(19) United States
(12) Patent Application Publication
(10) Pub. No.: US 2026/0052047 A1
(43) Pub. Date: Feb. 19, 2026

(54) Network Configuration of UE for Conditional Secondary Node Addition

(71) Applicant: Apple Inc., Cupertino, CA (US)

(72) Inventors: Naveen Kumar R PALLE VENKATA, San Diego, CA (US); Alexander SIROTKIN, Hod Hasharon (IL); Fangli XU, Beijing (CN); Haijing HU, Los Gatos, CA (US); Peng CHENG, Beijing (CN); Ping-Heng KUO, London (GB); Ralf ROSSBACH, Munich (DE); Yuqin CHEN, Beijing (CN); Zhibin WU, Los Altos, CA (US)

(21) Appl. No.: 19/102,328

(22) PCT Filed: Aug. 9, 2022
(86) PCT No.: PCT/CN2022/111198

§ 371 Date: Feb. 7, 2025

(51) Int. Cl. H04L 27/26; H04W 36/00

(52) U.S. Cl. CPC H04L 27/261; H04W 36/0069

(57) ABSTRACT

master nodes (MNs) and one or more candidate secondary nodes (SNS). The UE is configured to measure a reference signal of the one or more candidate SNs, determine whether to add a first one of the candidate SNs as an SN for the UE based on at least the reference signal measurement of the first one of the candidate SNs and receive, from a network, a configuration indicating the UE has an option to not add the one or more SNs as the SN for the UE.

### TECHNICAL FIELD

The present disclosure generally relates to wireless communication, and in particular, to network configuration of UE for conditional secondary node addition.

### BACKGROUND

A user equipment (UE) may establish a connection to at least one of a plurality of different networks or types of networks, for example a 5G New Radio (NR) radio access technology (RAT) and a Long-Term Evolution (LTE) RAT. The UE may support standalone (SA) carrier aggregation (CA) on LTE, SA CA on NR (NR-CA), or a variety of non-standalone (NSA) and/or dual-connectivity (DC) functionalities in which a plurality of component carriers (CCs) are combined across LTE and/or NR. In NR-NR DC (NR-DC), the UE is connected to two cells or cell groups (CG) wherein one gNB acts as MN (or primary cell (PCell)) in a master CG (MCG) and another gNB acts as a secondary node SN (or primary secondary cell (PSCell)) in a secondary CG (SCG).

Conditional handover (CHO) relates to an operation in which the network provides the UE with a list of target cell(s) for CHO with a corresponding radio resource control (RRC) configuration, which are prepared for handover to the UE in advance of the actual handover. For each target cell, the source gNB provides at least one condition for the UE to perform CHO. The condition(s) may relate to a radio quality for the target cell, as determined by the UE. The UE performs measurements on the target cells and, when the condition is satisfied for a target cell, the UE starts CHO and applies the preconfigured target cell configuration immediately. With CHO, the UE is able to perform handover without the involvement of the source cell, e.g., even when a radio quality of the connection with the source cell has degraded such that a source cell-initiated handover is not possible.

In 5G New Radio (NR), conditional configurations can be used for CHO and/or for changing a MCG or a SCG in DC operation. It may be desirable in Rel-18 to minimize the signaling needed for the UE to change CGs, e.g., to handover from a source SN of a first SCG to a target SN of a second SCG in NR-DC operation. Additionally, CHO can be specified in NR-DC in scenarios where one or more target MCGs and multiple candidate SCGs are available.

### SUMMARY

Some exemplary embodiments are related to a processor of a user equipment (UE) that is configured with one or more candidate master nodes (MNs) and one or more candidate secondary nodes (SNs). The processor is configured to perform operations that include measuring a reference signal of the one or more candidate SNs, determining whether to add a first one of the candidate SNs as an SN for the UE based on at least the reference signal measurement of the first one of the candidate SNs and receiving, from a network, a configuration indicating the UE has an option to not add the one or more SNs as the SN for the UE.

Other exemplary embodiments are related to a processor of user equipment that is configured with one or more candidate master nodes (MNs) and one or more candidate secondary nodes (SNs). The processor is configured to perform operations that include measuring a reference signal of the one or more candidate SNs, determining whether to add a first one of the candidate SNs as an SN for the UE based on at least the reference signal measurement of the first one of the candidate SNs and receiving, from a network, a configuration indicating the UE has an option to add the one or more SNs in a deactivated state as the SN for the UE.

Still further exemplary embodiments are related to a processor of base station operating as a master node (MN) for a user equipment (UE). The processor is configured to perform operations that include transmitting reference signals to the UE and transmitting a configuration to the UE, wherein the configuration indicates the UE has an option to not add one or more candidate secondary nodes (SNs) as an SN for the UE or the UE has an option to add the one or more candidate SNs in a deactivated state as the SN for the UE.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary base station according to various exemplary embodiments.

FIG. 4 shows an exemplary timing diagram for UE selection of SNs according to various exemplary embodiments.

FIG. 5 depicts a signaling message for adding SCGs according to various exemplary embodiments.

FIG. 6 shows an alternative exemplary timing diagram for UE selection of SNs according to various exemplary embodiments.

### DETAILED DESCRIPTION

The exemplary embodiments may be further understood with reference to the following description and the related appended drawings, wherein like elements are provided with the same reference numerals. The exemplary embodiments relate to improved methods and interpretations of conditional MN/SN configurations. Specifically, a network provides permissions to the UE that allow the UE to determine whether to add an SN or to add an SN in a deactivated state.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network.

Therefore, the UE as described herein is used to represent any electronic component.

The exemplary embodiments are also described with reference to a 5G New Radio (NR) network. However, it should be understood that the exemplary embodiments may also be implemented in other types of networks, including but not limited to LIE networks, future evolutions of the cellular protocol (e.g., 6G networks), or any other type of network that allows conditional configurations.

A UE may utilize multiple conditional MN/SN configurations. A conditional configuration may have multiple candidate MNs, and each candidate MN may have multiple candidate SNs. These conditional configurations may lack a unique ID for every MN/candidate SN. Alternatively, the MN/SN configurations may feature a configuration ID for every MN configuration, with a separate nested ID is present for candidate SNs within the MN.

The exemplary embodiments describe signaling and logic to be applied if the UE is near candidate nodes, and if the UE is not near candidate nodes. Should the UE be near the candidate nodes, the UE may apply the MN/SN configuration. If the UE is not near all the candidate nodes, the UE may apply the exemplary embodiments in deciding how to handle the networking situation. Flexibility in how the UE applies conditional configurations is desirable to avoid the link failure scenario where the UE is waiting for an SN.

The exemplary embodiments describe the actions of the UE after application of a conditional configuration, method(s) for the UE to inform the network about the actions the UE has performed, and the configuration of the network based on the actions of the UE.

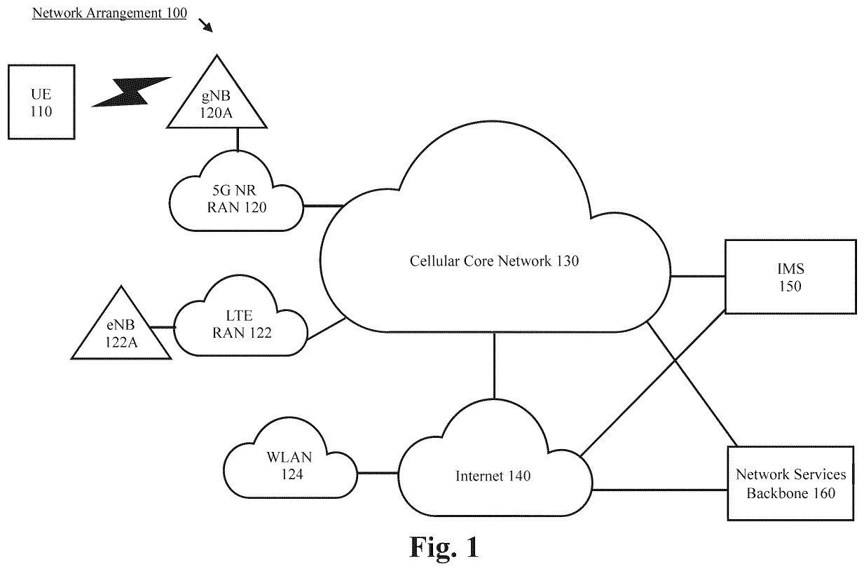

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120, an LTE RAN 122 and a wireless local area network (WLAN) 124. However, it should be understood that the UE 110 may also communicate with other types of networks (e.g., 5G cloud RAN, a next generation RAN (NG-RAN), a legacy cellular network, etc. ) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120.

The 5g Nr Ran 120 May Be Portions of a Cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.). The WLAN 124 may include any type of wireless local area network (Wifi, Hot Spot, IEEE 802.11x networks, etc.) .

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., the gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

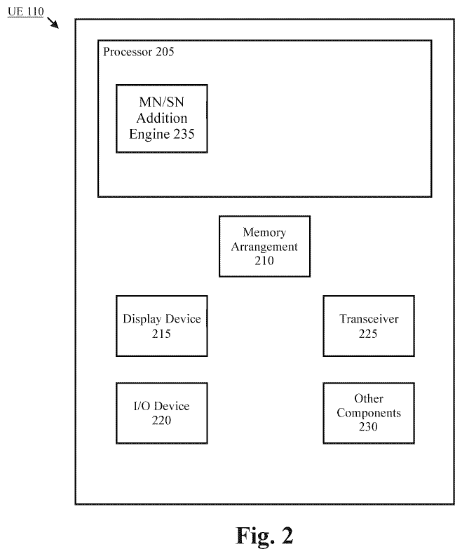

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230.

The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a MN/SN addition engine 235 for performing operations including evaluating network conditions and deciding whether to add an SN. These operations will be described in greater detail below.

The above referenced engine being an application (e.g., a program) executed by the processor 205 is only exemplary, The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR RAN 120, the LTE RAN 122 etc. Accordingly, the transceiver 225 may operate on a variety of different frequencies or channels (e.g., set of consecutive frequencies). For example, the transceiver 225 may operate on the unlicensed spectrum when e.g., NR-U is configured.

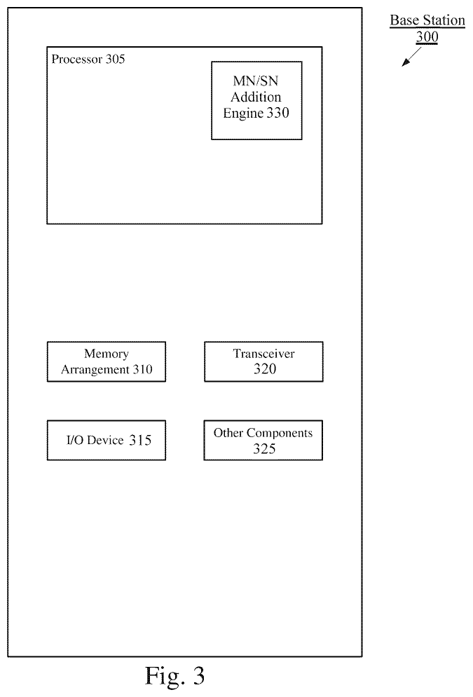

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320 and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines of the base station 300. For example, the engines may include a MN/SN addition engine 330 for performing operations including allowing a UE to choose not to add an SN or to allow the UE to add an SN in a deactivated state. Each of these operations will be described in more detail below.

The above noted engine 330 being an application (e.g., a program) executed by the processor 305 is only exemplary. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.) . The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set 4-consecutive frequencies). Therefore, the transceiver 320 may include one or more components (e.g., radios) to enable the data exchange with the various networks and UEs.

Existing MN/SN configuration logic may result in link failure if the UE is forced to wait for an SN connection. Those of skill in the art will recognize that there is a need for improved MN/SN configuration logic, on both the UE and network side.

One of skill in the art will recognize that a UE waiting for conditional triggers for SNs may result in substantial wait times. This may result in radio link failure on the MN. In these situations, an SN may not be added without losing continuity of the connection. A SN can be added in a deactivated SCG state. In this case, the UE does not perform RACH with the deactivated SCG when added.

In a first aspect of the exemplary embodiments, a UE logic for application of MN/SN configurations is provided. A UE may be configured with candidate MNs and candidate SNs (for the MNs). This may also include the case of a single SN for an MN where there is a trigger for the conditional SN.

The first aspect will be described with respect to two scenarios. In a first scenario, it may be considered that the UE is not currently configured with an MN or an SN, e.g., the UE is not in dual-connectivity (DC) mode. In this scenario and in the second scenario it may be considered that the UE may be configured with multiple candidate SNs but only one SN may be added as an SN at a given time.

In a first option to handle the first scenario, the UE may have the option of not adding the candidate SN as part of conditional SN change. It should be understood that this means that the condition that was configured by the network for adding a candidate SN as an SN is satisfied but the UE is independently allowed to not follow this condition. This decision may be made if the candidate SN reference signal quality is below a certain threshold. The decision not to apply the conditional SN configuration may also be based on any other configured checks by either the network or the UE, e.g., the network or UE implement one or more criteria which indicate that it is not necessary for the UE to add an SN.

In a second option, the UE may instead choose to add the candidate SN as an SN in a deactivated secondary cell group (SCG) state. The criteria for adding the SN in the deactivated state may be similar to the criteria described above for not adding the SN, e.g., comparison of SN reference signal quality to a threshold, network defined criteria, UE defined criteria, etc. This addition of the SN in the deactivated state may occur even when the network conditional configuration does not have a deactivated state as the starting node configuration.

For both above options, the UE may inform the network of the decision. Specifically, the UE may inform the MN of the decision to add or not add a candidate SN as the SN for the UE. The UE may also inform the MN if the candidate SN was added as an SN in a deactivated SCG state. This may occur though an explicit signal, such as part of RRCReconfigComplete signaling to the MN, e.g., the RRCReconfigComplete message includes a specific indication (SN RRCReconfigComplete) of the candidate SN being configured as the SN for the UE. The UE may also inform the MN of its decision by the absence of an SN RRCReconfigComplete which is expected to be embedded within the MN message, e.g., the absence of the SN RRCReconfigComplete indicates to the MN that the candidate SN was not added as the SN for the UE.

In the second scenario of the first aspect of the exemplary embodiments, the UE may be currently configured with an SN and the UE is actively connected to the SN. If the UE encounters a new candidate SN (e.g., target SN) and the conditional change criteria is satisfied, the UE may have the option to add the target SN in a deactivated state. This implies that the target SN replaces the current SN. In addition, the criteria for adding the target SN in the deactivated state may be the same (or similar) to the criteria described above in the first scenario.

Similar to the first scenario, in this scenario, the UE may inform the MN about this decision in a similar manner to that discussed above, e.g., via explicit signaling (RRCReconfigComplete) or by the absence of the embedded message.

In a second aspect of the exemplary embodiments, the network may explicitly configure the UE as to the actions the UE should perform. For example, the network may configure the UE to indicate cases where the UE is not allowed to add an SN. In another example, the network may configure the UE to indicate cases where the UE is allowed to add an SN, but to keep the SN in a deactivated state. The network may allow the UE to add the SN in the deactivated state because the UE will report periodic SCG measurements for deactivated SCGs to the network. These measurements may be used by the network to activate the SN at a later time.

This configuration by the network may be performed with a simple configuration, e.g., a boolean or other manner of indicating whether not adding the candidate SN is allowed or whether deactivated state addition is allowed. The configuration may also include explicit thresholds that are separate from SN conditional configuration thresholds (e.g., add the candidate SN in the deactivated state when the reference signal quality is below a specified dBm).

These thresholds may be MN based. Adding a SN with a stronger or weaker threshold can be configured as the exit criteria for the network if the MN connection quality is weak. If the MN connection is strong (as determined by the UE), the decision to add an SN or the decision not to add an SN may have separate thresholds.

The decision to add an SN can also be entirely determined based on the SN connection quality. If the UE measures a signal that is a specified dBm weaker than the conditional threshold, the UE may not attempt to check the SN status for adding a MN.

The network may also configure whether the UE should skip adding an SN, or to add an SN in a deactivated state. This may occur whether or not the UE has dual-connectivity (DC).

In a third aspect of the exemplary embodiments, a logic is proposed for situations in which the UE does not add a SN, while the UE is operating in DC when the conditional configuration is provided.

A first option of the third aspect covers situations when the Packet Data Convergence Protocol (PDCP) for the SN is not activated, nor are RLC entities associated the SN PDCP activated. In this scenario, the SCG bearers may be deactivated. Alternatively, the UE has to add a target SN only when the associated trigger condition for the target SN is satisfied.

In a second option of the third aspect of the exemplary embodiments, all split bearers may be routed using an MN PDCP-leg. In this instance, the UE PDCP uses the MN-RLC entities for transfer.

Alternatively, signaling radio bearer 3 (SRB3) may be deactivated or the UE can use the MN to transfer SN RRC messages with SRB3.

In a third option of the third aspect of the exemplary embodiments, the beam failure detection (BFD) and RLM (radio link monitoring) on the SN are not performed as part the SN deactivated state. Alternatively, this may be based on a network configuration for the particular instance of the UE choosing not to add an SN.

In a fourth aspect of the exemplary embodiments, an SN adding logic for UEs that support back-to-back SN switches is proposed. The network may configure the UE to save a configuration. This saved configuration may then be used as part of a conditional configuration trigger. Not adding an SN may cause out of sync errors unless a reference configuration principle is followed.

No additional handling is required in situations where the SN may be added as deactivated and the UE switches to another SN before the current SN is activated. This scenario is similar to a UE operating in a currently SCG deactivated state when the conditional configuration is provided to the UE.

If the network intends to use the UE to perform back-to-back switches, the network may allow the UE to add an SN in a deactivated state.

Optionally, if the UE is configured to perform multiple back-to-back switches (e.g., the UE is provided a reference configuration, or there is an indication from the network to ask the UE to save the configuration), in the case where SN trigger condition is not yet satisfied but the MN condition is satisfied, the UE may add an SN in the deactivated state

If the UE has more than one SN to choose from, the UE may choose the best of the available SNs (based on the measured reference signal values) and then inform the network which SN is to be chosen in the deactivated state. Optionally, the network can also configure the UE with what to measure.

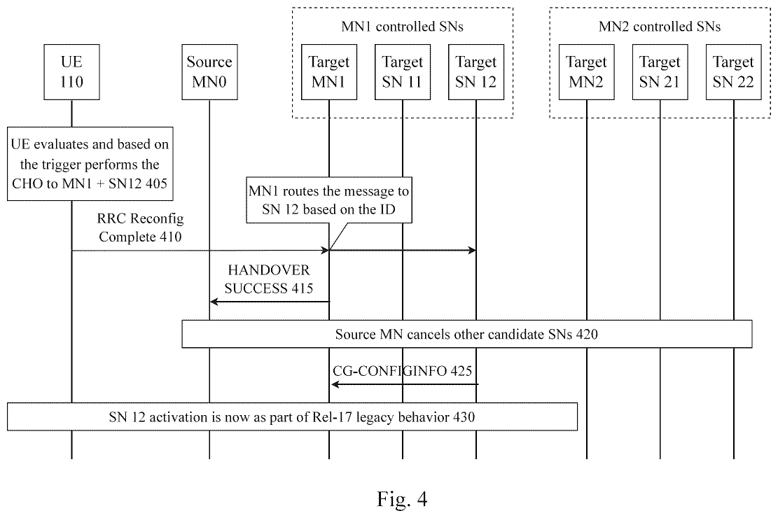

FIG. 4 shows an exemplary timing diagram for UE selection of SNs according to various exemplary embodiments. The UE may be understood to be UE 110. The UE 110 begins the timing diagram connected to a source MNO. In 405, UE 110 performs an evaluation (either based on a signal measurement or a checklist), and based on a trigger, performs a CHO to MN1 and SN12.

In 410, UE 110 transmits an RRCReconfigComplete message to the target MN1. The target Mn1 routes the message to SN12 based on the ID of the message. It should be noted that the message may indicate to the SN12 that the SN is not to be activated, or that the SN12 is to be added in a deactivated state.

In 415, the target MN1 Transmits a Handover Success message to the UE 110. In 420, the source MN cancels other candidate SNs. In FIG. 4, these may be understood to be target MN2, target SN21, and target SN22 though these nodes are only exemplary and it should be understood that this cancelation applies to any other node other than the selected nodes (i.e., MN1, SN11, SN12).

In 425, the target SN 12 sends a cg-configinfo message to the MN1. This informs the MN1 that SN12 is deactivated. In 430, the SN12 is activated accordingly to 3GPP release 17 legacy behavior.

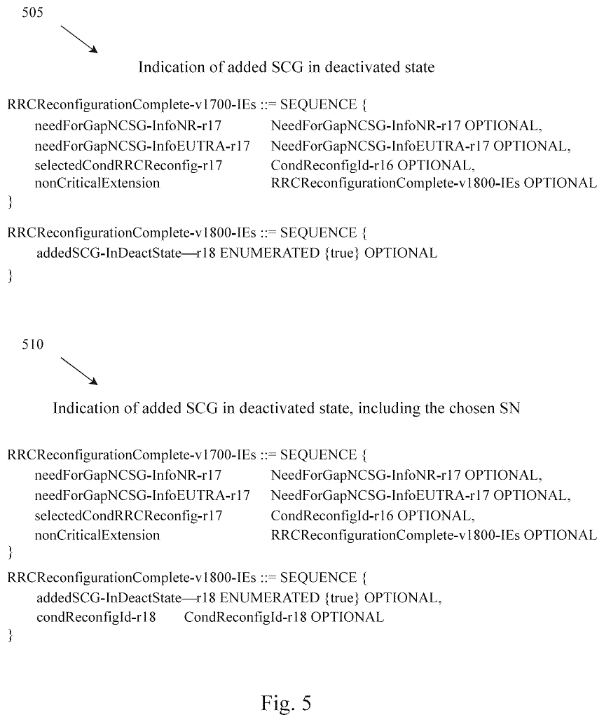

FIG. 5 depicts a signaling message for adding SCGs according to various exemplary embodiments. This signaling message may be the RRC Reconfig complete 410 as described in FIG. 4.

505 shows an exemplary indication of an added SCG in a deactivated state. 510 shows an exemplary indication of an added SCG in a deactivated state, including the chosen SN. This 510 indication may be utilized when there are multiple target SNs. The indication may contain an identifier allowing the MN to route the indication to the identified SN.

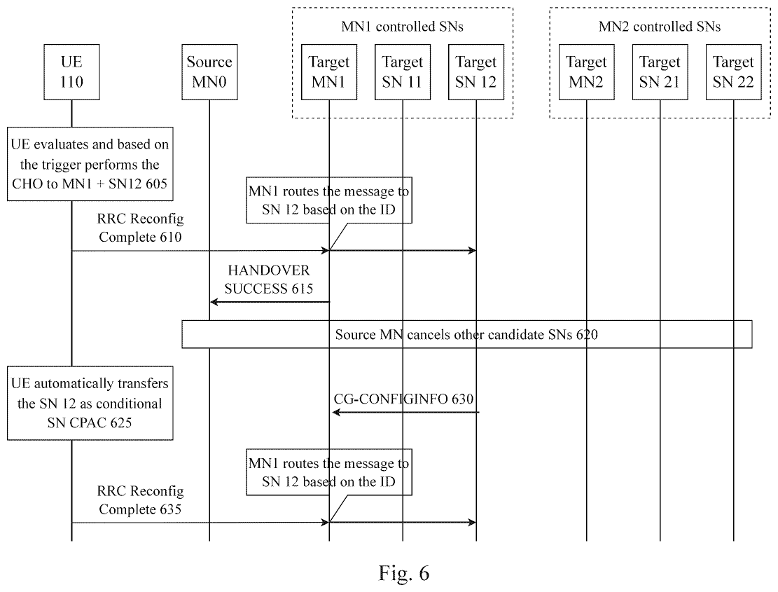

FIG. 6 shows an alternative exemplary timing diagram for UE selection of SNs according to various exemplary embodiments. 605-630 proceed in a substantially similar manner to 405-425 as discussed above with respect to FIG. 4. Beginning with the first point of difference, in 625 the UE may automatically transfer the SN12 as conditional SN Conditional PSCell Addition/Change (CPAC) if the conditions of both target MN1 and target SN12 are satisfied, the UE 110 may skip 610-620 and proceed directly to 625.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above-described method may be embodied as a program containing lines of code stored on a non-transitory computer readable storage medium that, when compiled, may be executed on a processor or microprocessor.

Although this application described various aspects each having different features in various combinations, those skilled in the art will understand that any of the features of one aspect may be combined with the features of the other aspects in any manner not specifically disclaimed or which is not functionally or logically inconsistent with the operation of the device or the stated functions of the disclosed aspects.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A processor of user equipment that is configured with one or more candidate master nodes (MNs) and one or more candidate secondary nodes (SNs), the processor configured to perform operations comprising:
measuring a reference signal of the one or more candidate SNs;
determining whether to add a first one of the candidate SNs as an SN for the UE based on at least the reference signal measurement of the first one of the candidate SNs; and
receiving, from a network, a configuration indicating the UE has an option to not add the one or more SNs as the SN for the UE.

2. The processor of claim 1, wherein the configuration comprises one or more thresholds related to whether to add or not add the one or more SNs as the SN for the UE.

3. The processor of claim 1, wherein the configuration indicates the UE has an option to not add the one or more SNs as the SN for the UE based on a UE capability related to dual-connectivity (DC).

4. The processor of claim 1, wherein the operations further comprise:
determining secondary cell group (SCG) bearers are present, wherein the UE adds the first one of the candidate SNs as the SN only when associated trigger conditions specific to the first one of the candidate SNs are satisfied.

5. The processor of claim 1, wherein the UE does not add the first one of the candidate SNs as the SN and the UE is in a dual-connectivity (DC) mode.

6. The processor of claim 5, wherein the operations further comprise:
omitting activating a packet data convergence protocol (PDCP) for the SN;
omitting activating radio link control (RLC) entities associated with the PDCP for the SN; and
deactivating secondary cell group (SCG) bearers.

7. The processor of claim 5, wherein the operations further comprise:
routing all split bearers using a packet data convergence protocol (PDCP) for an MN; and
using radio link control (RLC) entities associated with the PDCP for the MN for all transfer messages.

8. The processor of claim 5, wherein the operations further comprise:
deactivating signaling radio bearer 3 (SRB3).

9. The processor of claim 5, wherein the operations further comprise:
transferring radio resource control (RRC) messages of the SN using signaling radio bearer 3 (SRB3).

10. The processor of claim 1, wherein the UE adds the first one of the candidate SNs in a deactivated state and wherein beam failure detection (BFD) and radio link monitoring are not performed when the SN is in the deactivated state.

11. The processor of claim 1, wherein the UE adds the first one of the candidate SNs in a deactivated state, the operations further comprising:
receiving a configuration from the MN indicating whether beam failure detection (BFD) and radio link monitoring are to be performed when the SN is in the deactivated state.

12. A processor of user equipment that is configured with one or more candidate master nodes (MNs) and one or more candidate secondary nodes (SNs), the processor configured to perform operations comprising:
measuring a reference signal of the one or more candidate SNs;
determining whether to add a first one of the candidate SNs as an SN for the UE based on at least the reference signal measurement of the first one of the candidate SNs; and
receiving, from a network, a configuration indicating the UE has an option to add the one or more SNs in a deactivated state as the SN for the UE.

13. The processor of claim 12, wherein the configuration comprises one or more thresholds related to whether to add the one or more SNs in a deactivated state as the SN for the UE.

14. The processor of claim 13, wherein the one or more thresholds are based on a signal quality of reference signals measured for an MN.

15. The processor of claim 12, wherein the configuration indicates the UE has an option to not add the one or more SNs in a deactivated state as the SN for the UE based on a UE capability related to dual-connectivity (DC).

16. The processor of claim 12, wherein the UE supports back to back switches of the SN, the operations further comprising:
receiving, from the MN, a configuration indicating the UE is to add the first one of the candidate SNs in a deactivated state.

17. The processor of claim 12, wherein the UE supports back to back switches of the SN, the operations further comprising:
receiving, from the MN, a reference configuration or a configuration indicating the UE is to save a configuration for the first one of the candidate SNs; and
adding the first one of the candidate SNs in a deactivated state when an SN trigger condition is not satisfied but a MN trigger condition is satisfied.

18. The processor of claim 17, wherein, when the one or more candidate SNs comprises a plurality of SNs, the first one of the candidate SNs is selected based on the corresponding measured reference signal.

19. A processor of base station operating as a master node (MN) for a user equipment (UE), the processor configured to perform operations comprising:
transmitting reference signals to the UE; and
transmitting a configuration to the UE, wherein the configuration indicates the UE has an option to not add one or more candidate secondary nodes (SNS ) as an SN for the UE or the UE has an option to add the one or more candidate SNs in a deactivated state as the SN for the UE.

20. The processor of claim 19, wherein the configuration comprises one or more thresholds related to whether to add the one or more SNs as the SN for the UE or to add the SN in a deactivated state as the SN for the UE, wherein the one or more thresholds are based on a signal quality of the reference signals transmitted by the MN and measured by UE.
